(19) United States
(12) Patent Application Publication
(10) Pub. No.: US 2002/0111849 A1
(43) Pub. Date: Aug. 15, 2002

(54) Method of using a regional input-output model as a template for a regional metropolitan industry-to-industry internet electronic commerce web site to continuously update technical coefficients in a regional econometric input-output model

(76) Inventor: Thomas E. Vass, Raleigh, NC (US)

Correspondence Address: COATS & BENNETT, PLLC, P O BOX 5, RALEIGH, NC, 27602, US

(21) Appl. No.: 09/781,729

(22) Filed: Feb. 12, 2001

(51) Int. Cl. G06F 17/60

(52) U.S. Cl. 705/10; 705/7; 705/26; 705/37

(57) ABSTRACT

A computerized method and system for deriving data from sales and purchasing transactions that occur between firms in certain industrial sectors within a region to update continuously technical coefficients in an input-output model of a regional economy comprising mapping the accounting framework of a regional inter-industry input-output transaction table onto an Internet electronic commerce web site to provide a logical framework for the collection of data regarding inter-industrial transactions between firms.

### FIELD OF THE INVENTION

The present invention relates to a computerized method and system for deriving data from sales and purchasing transactions that occur between firms in certain industrial sectors within a region to update continuously technical coefficients in an input-output model of a regional economy.

### BACKGROUND OF THE INVENTION

Regional economic development occurs as a result of diversification in products produced and increasing inter-industry trading relations among production units in the region. The diversification in products and increased industrial linkages are caused by technological change in production processes, which increase productivity in the production units which adopt technological innovations in production processes. The improved productivity creates new flows of income within the region, and creates potential new pools of venture capital, as new ventures that adopted technological innovations are either sold for capital gains or issue publicly traded securities through an initial public offering of equity units. The econometric method of input-output analysis allows the observer to view how technical coefficients change over time as a result of new or different trading relationships in intermediate industrial demand among a region's firms. Regional technical coefficients change as a result of the adoption of new production processes and the introduction of new products within a regional economy.

The existing state of the art in the development of a regional input-output model entails a detailed survey of the sales and purchases of individual firms and establishments within a region. Data from the survey of firms are placed within a matrix of rows and columns to describe how firms in one industrial sector buy inputs from firms in other industrial sectors (column entries) in the region to make products, and to which firms in an industrial sector in the region the firms sell their products (row entries). The initial set of sales and purchase data, once placed in the matrix format, constitutes the input-output transaction matrix. When all the column entries in the transaction matrix are added for each column, the total summation figure can act as the divisor for each column cell entry to derive a technical coefficient matrix. The resulting technical coefficient matrix is derived from the transaction matrix which is derived from the survey of purchases and transactions. The survey method is cumbersome to conduct and costly to maintain and update. Further, the initial survey-based transaction data represent a snapshot of the regional economic structure at the moment in time of the survey and, as the regional economy experiences technical change, the accuracy and validity of the technical coefficient matrix declines. Survey data may also be unreliable as a result of data gathering difficulties. Thus, an alternate to this survey method is needed.

### SUMMARY OF THE INVENTION

The present invention entails a method of identifying sales and purchase transactions that occur between firms in industrial sectors in a given region. In identifying data from the sales and purchases that occur between firms in industrial sectors, the present invention entails the use of a regional input-output transaction matrix as a template to provide an accounting framework to place the data into an analytical framework. The input-output analytical accounting framework allows for further analysis of inter-industrial relationships within the region.

In one application of this method, a business to business web site will be created for a specific region. Each industrial sector will be represented in the cells of the transaction matrix of rows and columns. Each firm or establishment identified as a member of an industrial sector may voluntarily enter transactions for purchases or sales with other firms or establishments, using the web site host computer as a communication medium. In a second application of this method, firms or establishments may enter into voluntary negotiations over the price and terms and conditions associated with transactions with other firms, using the web site host computer as a communication medium. Additionally, the web site host computer will continually monitor the transactions that occur between firms and establishments over a fixed interval of time, and transmit the data on transactions to a computer database. In a further application of this method, the web site computer software algorithm will identify additional new ventures that may have been created in the region whose creation would entail entirely new transaction relationships in the region that would entail modification of the original input-output accounting framework that had initially been mapped onto the electronic web site. Essentially, the appearance of new firms entering transactions on the web site causes a feedback loop in which the computer software modifies the input-output transaction matrix to reflect new firms in industrial sectors in the region.

The computer database will employ a computer software algorithm that may continually evaluate and monitor the pattern of transactions that occur within the regional transaction matrix to determine how regional inter-industry trading relationships are changing over time. In one application of this method, the computer software algorithm will convert the transaction matrix data into technical coefficients in a technical coefficients matrix to provide for further analysis and evaluation of the regional economy.

### BRIEF DESCRIPTION OF THE DRAWINGS

FIG. 1 is a schematic illustration of the computerized system for the present invention for using a regional metropolitan Industry to Industry Internet electronic commerce web site to update continuously technical coefficients in a regional econometric input-output model.

FIG. 2 is a schematic illustration of the chronological sequence of events in time that occur in the transformation of data taken from the purchase and sales transactions which occur on the electronic commerce web site into technical coefficients in a regional metropolitan econometric input-output model.

FIG. 3 is a listing of the possible different types of transactions that occur on the e-commerce web site that would result in purchase and sales data that would be transformed into technical coefficients in a regional metropolitan econometric input-output model.

### DETAILED DESCRIPTION OF THE INVENTION

The present invention entails a computerized method and system for deriving data from sales and purchasing transactions that occur between firms in certain industrial sectors within a region to update continuously technical coefficients in an input-output model of a regional economy. Further, the present invention entails mapping the accounting framework of a regional inter-industry input-output transaction table onto an Internet electronic commerce web site to provide a logical framework for the collection of data regarding inter-industrial transactions between firms. The input-output accounting framework allows for further analysis of inter-industrial relationships within the region. Certain firms in industrial sectors buy and sell products from firms in other sectors, and do not have inter-industrial trading relationships with firms in other sectors.

The present invention entails continuous monitoring of the purchase and sales transactions between firms in certain industrial sectors that occur on the electronic commerce Internet web site. Based upon the continual monitoring and evaluation of the transaction data observed between firms, the present invention entails transforming the transaction data into entries consisting of the technical coefficients in a regional inter-industrial input-output model.

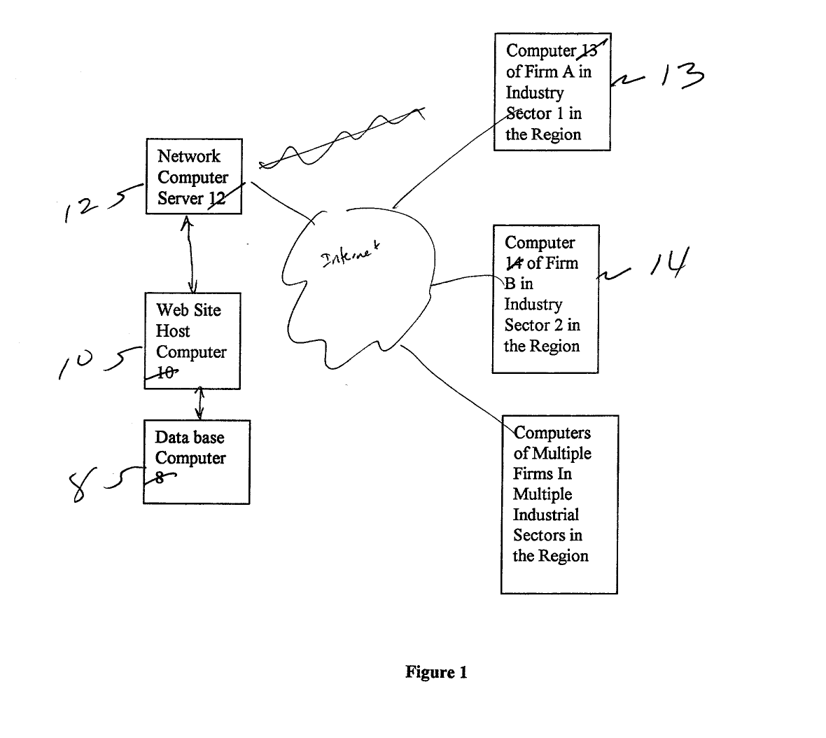

Basically, as illustrated in FIG. 1, a computer 10 is connected to a computer network server 12. Multiple other computers 13 and 14 are connected to the computer network server 12 via a transmission connection. The computerized network formed by the transmission connection can form a part of a metropolitan area network or can be connected over a network connection such as the Internet through a public switched telecommunications network or through private network lines using fiber optic cables or coaxial cables to form the transmission connection. In any event, the computer 10 is operative to receive data and information relating to a large number of transactions involving firms linked to the network and such information is received and stored on a temporary basis in the memory of the computer 10. Through appropriate software, the data and information pertaining to the transactions that are stored on a temporary basis in the memory of the computer 10 can be transferred to and stored in a computer 8 database. The computer 8 database collects and stores all data on transactions that occur between firms from all industries in the region as captured by transactions on the electronic commerce Internet web site that have been stored in the temporary memory at computer 10.

The transaction data in computer 8 database can be manipulated, evaluated, analyzed and modified by additional data from outside the network. The further analysis and evaluation of the transaction data is performed through the application of software that is designed to conduct certain types of mathematical matrix operations on the transaction data. Further, the software can be designed to transform the transaction data into technical coefficients of industrial sectors in the region to identify changes in the transaction patterns and inter-industrial relationships.

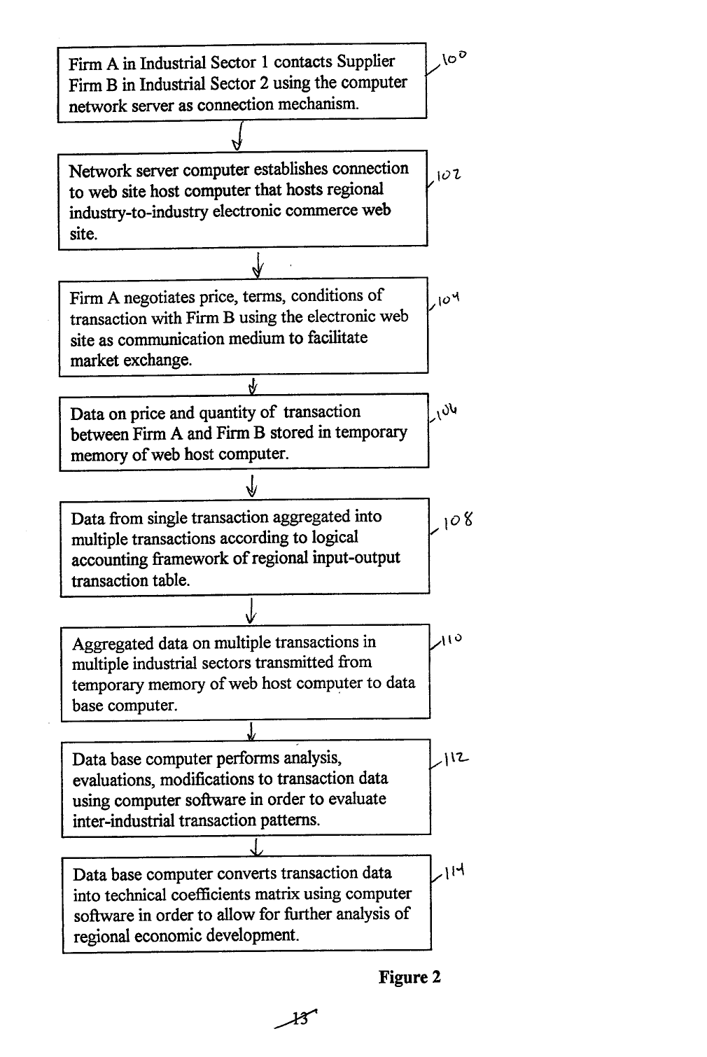

Turning to FIG. 2, there is shown therein a schematic representation of the chronological events in time that occur in the process of transforming purchase and sales data taken from the e-commerce web site into technical coefficients in a regional metropolitan econometric input-output model. The process or method begins with a firm in industry A contacting a firm in supplier industry B using the web site hosted on computer 10 as a communication medium that facilitates transactions between firms. Essentially, the computer 13 of the firm in industry A uses the computer network server 12 to contact the computer 14 of the firm in industry B to purchase supplies from firm B (block 100). The computer 13 at the firm in industry A and the computer 14 at the firm in industry B are communicatively connected to the computer network server 12 (block 102). As pointed out above the transmission network that connects the computers to the computer network server may be part of a metropolitan area network or a public network such as an Internet or may be a private transmission network of either firm. In any event, as described in FIG. 2, in the context of the present invention, the computerized network allows the firms to negotiate the terms and conditions associated with the transaction using the web site host computer 10 as a common communication medium (block 104). Basically, the firms execute a contract for purchase and sale of supplies, using the web site computer as a medium to facilitate a market exchange. As described in FIG. 2, data on the terms and conditions of the transaction pertaining to quantity and price are collected and stored in the computer 10 (block 106). The data are collected and stored in cells provided by the accounting framework of the input-output model that is mapped onto the web site. Essentially, data from each single transaction between firms in industry A and firms in industry B are collected and stored in the web site host computer 10. At fixed intervals of time, data on each single transaction that occurs between firms in industry A and firms in industry B are transferred to and stored in a database at computer 8 (block 110). Computer 8 database stores data from multiple transactions that occur over fixed intervals of time between firms in industry A and firms in industry B. Additionally, the computer 8 database receives and stores transaction data for the entire population of firms in industrial sectors who have voluntarily chosen to link the computers in their firms to the e-commerce web site host computer through the connection established with computer 12 network server. Transaction data that may occur between all firms for the entire region are mapped into the logical accounting framework of a regional input-output model in the database of computer 8 (block 112). As described in the schematic provided in FIG. 2, the computer 8 can convert the transaction data in the database data into regional technical coefficients (block 114) using appropriate computer software algorithms. The technical coefficients would be derived from the data on inter-industry sales and purchases for intermediate inputs from each industrial sector located in the regional economy. The technical coefficients would be arranged in a matrix of rows and columns according to a classification scheme of industrial sectors developed by the U.S. Department of Commerce called standard industrial classification (SIC). Each row in the matrix has cells, wherein data representing regional inter-industry transaction for sales of output from a firm in industry A to a firm in industry B has been converted from transaction data into technical coefficients. Each column in the matrix has cells, wherein economic data representing regional inter-industry transactions for purchases of inputs of supplies from firms in industry B to firms in industry A has been converted to technical coefficients. These technical coefficients are explained in greater detail in copending U.S. patent application Ser. No. 09/616,249, filed Jul. 14, 2000, which is hereby incorporated by reference.

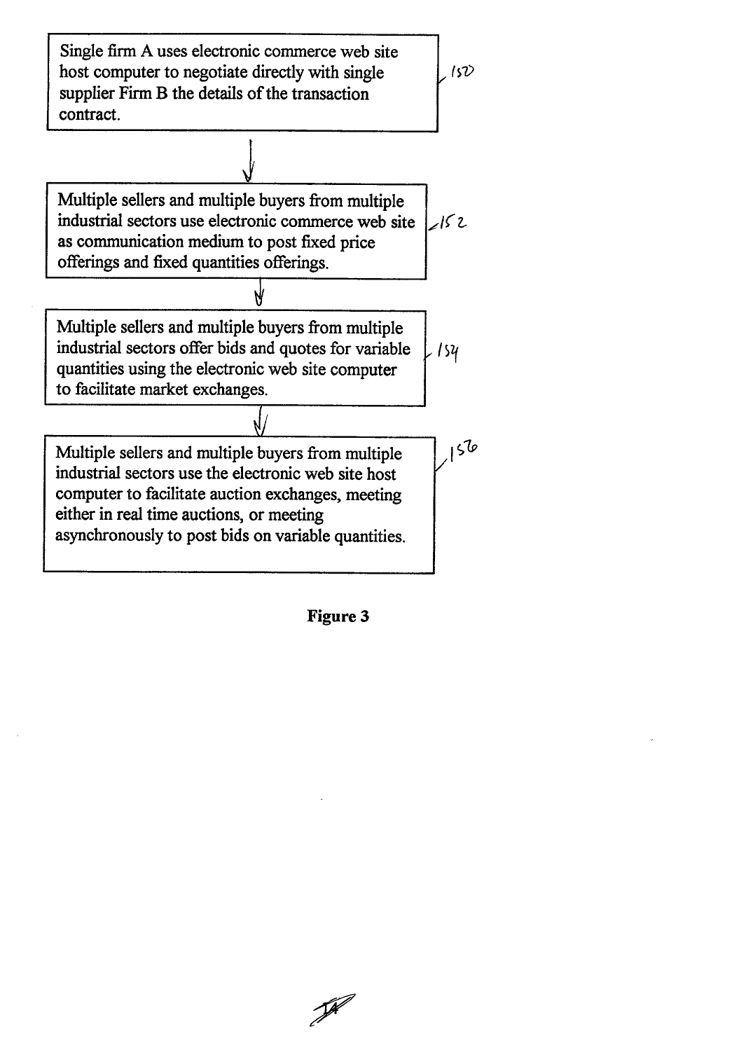

Turning to FIG. 3, the transaction data that is converted into technical coefficients is derived from observations of transactions that occur between firms on an electronic commerce Internet web site. A number of different types of transactions occur on the web site that would provide useful data that would be transmitted to the database in computer 8 for further evaluation and analysis of inter-industry relationships. Essentially, transaction data can be derived from a contract negotiated between a single buyer and a single seller who use the web site host computer as an electronic market meeting place to negotiate the terms and conditions of a transaction. The terms and conditions of the price and quantity of the negotiated contract would be useful data to be transmitted to the database at computer 8 (block 150). Additionally, multiple sellers and multiple buyers may post fixed prices for fixed quantities. The web site host computer would monitor transactions involving fixed prices and fixed quantities and transmit transaction data to the database at computer 8 (block 152). Additionally, multiple buyers and multiple sellers may use the web site host computer to enter price bids and quotes for variable quantities. Bids and quotes that are executed for variable quantities would represent useful data to be transmitted to the database at computer 8 (block 154). Additionally, multiple buyer and multiple sellers could meet simultaneously in real time, or through an asynchronous method of meeting on the web site host computer 10 to engage in an auction style of transaction, whose data would be useful to transmit to the database at computer 8 (block 156). In any event, the method entailed in this invention allows for transaction data derived from different types of transactions to be transmitted to the database at computer 8 to be stored and held for further evaluation and analysis.

The concept of a technical coefficient matrix is well-known and appreciated by those ordinarily skilled in the art and therefore a detailed discussion of how technical coefficient matrixes are produced are not dealt with herein in detail. For a more complete and unified understanding of technical coefficient and technical coefficient matrixes, one is referred to the following publications: “Input-Output Data Base for Analysis of Technical Change,” Wassily Leontief (1989), Economic Systems Research, (Vol. 1 #3); “National Industry Cluster Templates: A Framework For Applied Regional Cluster Analysis,” Edward J. Feser and Edward M. Bergman (2000), Regional Studies, (Vol. 34 #1); Structural Change in the American Economy, Anne P. Carter (1970), Cambridge: Harvard University Press; and “The Fundamental Structure of Input-Output Tables: An International Comparison,” David Simpson and Jinkichi Tsukui (1998) Input-Output Analysis, Volume III, Eds. Heinz D. Kurtz, Erik Dietzenbacher, Christian Lager, Cheltenham:Edward Elgar.

The present invention may, of course, be carried out in other specific ways than those herein set forth without departing from the scope and the essential characteristics of the invention. The present embodiments are therefore to be construed in all aspects as illustrative and not restrictive and all changes coming within the meaning and equivalency range of the appended claims are intended to be embraced therein.

1. A method of promoting commerce comprising: using a regional metropolitan industry to industry Internet electronic commerce website to update technical coefficients in a regional econometric input-output model.

2. The method of claim 1 further comprising continuously updating said electronic commerce website.

3. The method of claim 2 wherein using a regional metropolitan industry to industry Internet electronic commerce website comprises accepting orders from industries through the website.

4. The method of claim 2 wherein using a regional metropolitan industry to industry Internet electronic commerce website comprises tracking transactions between industries on the website.

5. The method of claim 1 further comprising establishing an industry to industry electronic commerce web site for a particular region.

6. The method of claim 4 further comprising converting transaction data derived from said tracking into a regional input-output matrix of technical coefficients.

7. The method of claim 1 further comprising recording transactions that occur between businesses on the electronic website.

8. The method of claim 4 further comprising identifying new businesses in new industrial sectors based on said tracking.

9. The method of claim 8 further comprising monitoring said new businesses in a specific region.

10. The method of claim 1 further comprising storing inter-industrial purchase and sales transaction data on a temporary basis in a website host computer.

11. The method of claim 10 further comprising collecting and storing data from single transactions between firms on a temporary basis on the website host computer.

12. The method of claim 11 further comprising transmitting data from the website host computer on a plurality of businesses in a plurality of sectors to a computer database.

13. The method of claim 12 further comprising collecting, storing, aggregating and analyzing data on multiple transactions that occur over a fixed time interval stored in said computer database.

14. The method of claim 1 further comprising allowing single buyers and single sellers to meet and negotiate terms and conditions of a transaction on said website.

15. The method of claim 14 further comprising tracking transactions entered into as a result of said allowing single buyers and single sellers to meet and negotiate terms and conditions of a transaction on said website.

16. The method of claim 1 further comprising allowing multiple buyers and multiple sellers to post fixed prices for fixed quantities to consummate a transaction on said website.

17. The method of claim 16 further comprising tracking transactions entered into as a result of allowing multiple buyers and multiple sellers to post fixed prices for fixed quantities to consummate a transaction on said website.

18. The method of claim 1 further comprising allowing an auction exchange market to occur on said website.

19. The method of claim 18 further comprising tracking transactions entered into as a result of said allowing an auction exchange market to occur on said website.

20. A computerized system for tracking regional economic activity comprising:
a computer hosting a website and being accessible by a plurality of computers remotely positioned from said computer;
said website forming a business to business e-commerce platform through which companies in a given region may buy and sell from one another through said plurality of computers; and
software associated with said computer that tracks transactions entered into via said website and collates information derived from said transactions to form a regional transaction matrix to determine how regional inter-industry trading relationships are changing over time.

21. A method of generating a technical coefficient matrix for an economy comprising: monitoring sales transactions conducted through an internet web site and extracting price and quantity information from the sales transactions and producing a technical coefficient matrix based on said internet transactions.

22. The method of claim 21 wherein the sales transactions monitored are from a regional economy.

23. The method of claim 21 wherein the technical coefficient matrix produced is based on a regional input-output model.

24. The method of claim 21 including continuing to update the technical coefficient matrix based on continuing transactions conducted through the internet web site.

25. The method of claim 21 wherein the sales transactions monitor include offers to sell.
